(19) United States
(12) Patent Application Publication
(10) Pub. No.: US 2013/0048438 A1
(43) Pub. Date: Feb. 28, 2013

(54) ELEVATOR SYSTEM WITH ROPE SWAY MITIGATION

(71) Applicants: Richard J. Mangini, Brookfield, CT (US); Randall Keith Roberts, Hebron, CT (US)

(72) Inventors: Richard J. Mangini, Brookfield, CT (US); Randall Keith Roberts, Hebron, CT (US)

(73) Assignee: OTIS ELEVATOR COMPANY, Farmington, CT (US)

(21) Appl. No.: 13/642,165

(22) PCT Filed: May 14, 2010
(86) PCT No.: PCT/US10/34915

§ 371 Date: Oct. 19, 2012

(51) Int. Cl. B66B 7/00

(52) U.S. Cl. 187/414

(57) ABSTRACT

An exemplary elevator system includes a first and second mass moveable within a hoistway. A plurality of elongated members couple the first mass to the second mass and move over a sheave near one end of the hoistway as the first and second masses move within the hoistway. A portion of the elongated members has a first end at the first mass and a second end at the sheave. A length of the portion between the first and second ends decreases as the first mass moves toward the end of the hoistway that includes the sheave. A damper remains in a fixed position relative to the first or second end. The damper includes an impact member that is spaced from the portion of the elongated members during acceptable operating conditions. The impact member contacts the elongated members responsive to lateral movement of the elongated members.

### BACKGROUND

Elevator systems are useful for carrying passengers between various levels in a building, for example. There are various known types of elevator systems. Different design considerations dictate what type of components are included in an elevator system. For example, elevator systems in high rise buildings have different requirements than those for buildings that include only a few floors.

One issue that is present in many high rise buildings is a tendency to experience rope sway under various conditions. Rope sway may occur, for example, during earthquakes or very high wind conditions because the building will move responsive to the earthquake or high winds. As the building moves, long ropes associated with the elevator car and counterweight will tend to sway from side to side. On some occasions rope sway has been produced when there are high vertical air flow rates in the elevator hoistway. Such air flow is associated with the well known “building stack or chimney effect.” Excessive rope sway conditions are undesirable for two main reasons; they can cause damage to the ropes or other equipment in the hoistway and their motion can produce objectionable vibration levels in the elevator cab.

Some proposed sway mitigation techniques involve a sway mitigation device that is activated responsive to a condition during which rope sway may occur. Such proposed sway mitigation devices are positioned at various locations within a hoistway where they are normally in a retracted or unactivated position so that they are outside of the path of travel of an elevator car. During sway conditions, the sway mitigation members are deployed or extended into the hoistway where they contact the ropes to minimize the amount of sway. A significant drawback associated with such arrangements is that the sway mitigation members have to be deployed to provide any benefit. This introduces complexity and cost into the elevator system. Additionally, they have to be maintained in a retracted or inactive position during an elevator run because they otherwise interfere with the travel path of the elevator car. Such sway mitigation devices are, therefore, not useable for reducing rope sway when the cab is moving.

### SUMMARY

An exemplary elevator system includes a first mass that is moveable within a hoistway. A second mass is moveable within the hoistway. At least one sheave is located near one end of the hoistway. A plurality of elongated members couple the first mass to the second mass. The elongated members move over the sheave as the first and second masses move vertically within the hoistway. A portion of the elongated members has a first end at the first mass and a second end at the sheave. The portion of the elongated members has a length between the first and second ends that decreases as the first mass moves toward the end of the hoistway that includes the sheave. A damper remains in a fixed position relative to the first or second end of the portion of the elongated members. The damper includes an impact member that is spaced from the portion of the elongated members during acceptable operating conditions (e.g., those involving little or no lateral elongated member motion). The impact member contacts at least some of the elongated members responsive to lateral movement of the elongated members as the first mass approaches the one end of the hoistway.

An exemplary method of controlling vibration in an elevator system includes moving an elevator car toward an end of a hoistway that includes at least one sheave such that a length of a portion of elongated members that couple the elevator car to a counterweight decreases as the elevator car moves toward that end of the hoistway. The portion of the elongated members between the elevator car and that end of the hoistway each have a first end near the elevator car and a second end at the sheave. A damper is positioned in a fixed position relative to one of the first or second end of the portion of the elongated members. The damper includes an impact member that is spaced from the portion of the elongated members during acceptable operating conditions. Vibration of the elevator car is damped by allowing at least some of the elongated members to contact the impact member as the elongated members move laterally as the elevator car approaches the end of the hoistway.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically shows selected portions of an example elevator system.

FIG. 2 is a perspective, diagrammatic illustration of an example damper.

FIG. 3 schematically illustrates another example damper.

FIG. 4 is a cross-sectional illustration taken along the lines 4-4 in FIG. 1 showing another example damper.

FIG. 5 is an elevational view of the example of FIG. 4.

### DETAILED DESCRIPTION

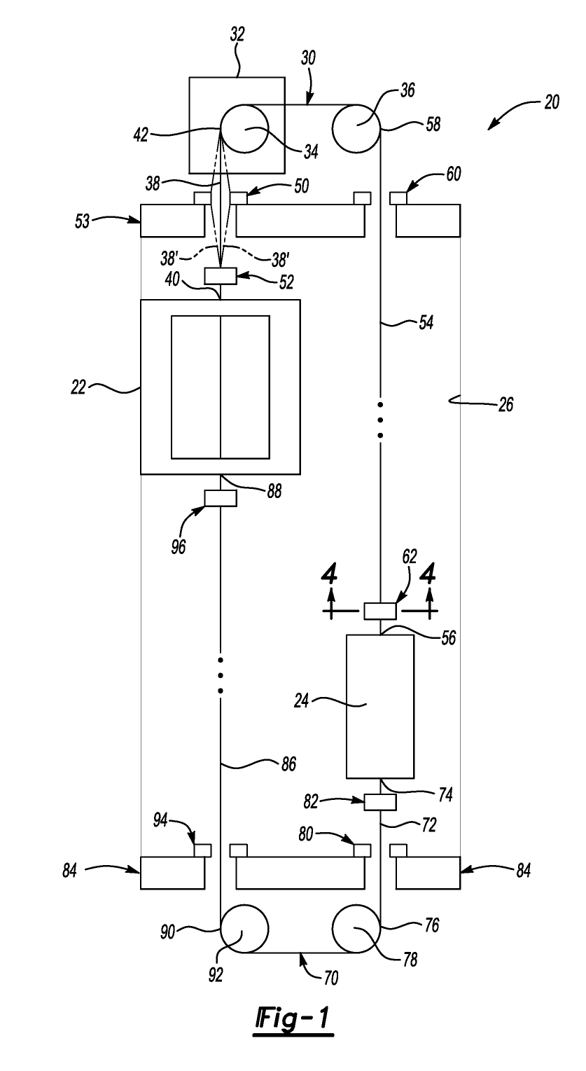

FIG. 1 schematically shows selected portions of an elevator system 20. An elevator car 22 and a counterweight 24 are both moveable within a hoistway 26. A plurality of traction ropes 30 couple the elevator car 22 to the counterweight 24. In one example, the traction ropes 30 comprise round steel ropes. A variety of roping configurations may be useful in an elevator system that includes features designed according to an embodiment of this invention.

In the example of FIG. 1, the traction ropes 30 are elongated member ropes that are used for supporting the weight of the elevator car 22 and the counterweight 24 and propelling them in a desired direction within the hoistway 26. An elevator machine 32 includes a traction sheave 34 that rotates and causes movement of the traction ropes 30 to cause the desired movement of the elevator car 22, for example. The example arrangement includes a deflector or idler sheave 36 to guide movement of the traction ropes 30.

During movement of the elevator car 22 under certain conditions, it is possible that the traction ropes 30 will move laterally in an undesirable manner. The traction sheave 34 is intended to cause longitudinal movement of the traction ropes 30 (e.g., along the length of the ropes). Lateral movement (e.g., transverse to the direction of longitudinal movement) is undesired, for example, because it introduces vibrations that reduce the ride quality for passengers within the elevator car 22, can produce objectionable noise, and can lead to elevator rope wear and reduced life.

A portion 38 of the traction ropes 30 between the elevator car 22 and the traction sheave 34 will have a tendency to move laterally under certain elevator operation conditions (e.g., during an elevator run), certain building conditions, certain hoistway conditions or a combination of two or more of these. For example, during an express run of the elevator car 22 from a low floor in the building to one of the highest floors on a windy day when the building is swaying, there may be a tendency for the traction ropes 30 to sway. The portion 38 may move laterally in a manner that causes vibration of the elevator car 22 especially as the swaying rope's length shortens during normal elevator motions. Such lateral movement or sway is schematically shown in phantom at 38′ in FIG. 1.

The example elevator system 20 includes at least one damper for mitigating the amount of rope sway to minimize the amount of vibration of the elevator car 22.

The portion 38 of the traction ropes 30 has a first end 40 at the elevator car 22. Conventional hitches may be used to secure the end of the traction ropes 30 to the structure of the elevator car 22 in a known manner. Alternatively, a sheave may be supported on the car 22 and the ropes 30 wrap at least partially around such a sheave. The first end 40 is associated with such hitches or such a sheave, for example. A second end 42 of the portion 38 exists at the interface between the traction ropes 30 and the sheave 34. As can be appreciated from the illustration, vibration or lateral movement of the portion 38 may occur between the first end 40 and the second end 42. As also can be appreciated from the drawing, a length of the portion 38 decreases as the elevator car 22 moves toward the machine 32.

When the length of the portion 38 decreases, the vibrational energy associated with sway or lateral movement of the traction ropes 30 shifts from lower frequencies (e.g., <1 Hz) to higher frequencies (e.g., >1 Hz) within the shortening length of the portion 38. This increased vibrational energy at higher frequencies tends to increase the likelihood that the elevator car 22 will vibrate. This is especially true during an express elevator run where the elevator car 22 is moving over a long distance within the hoistway from a point below the midpoint of the building, for example, to one of the highest floors in the building without any intermediate stops. An express run from a building entrance level or lobby to a floor near the top of a high rise building will tend to have the largest amount of undesired lateral movement of the traction ropes 30.

The example of FIG. 1 includes a damper 50 situated in a fixed position relative to the first end 42 of the portion 38. Another damper 52 is situated in a fixed position relative to the first end 40 of the portion 38. In this example, the damper 50 is supported on a structural member 53 of the hoistway 26 such as on a floor 53 associated with a machine room for housing the machine 32. The damper 52 is secured to at least one of the traction ropes 30 so that it remains in a fixed longitudinal position on at least one of the traction ropes 30. The dampers 50 and 52 reduce the amount of lateral movement or sway of the portion 38 of the traction ropes 30 by contacting at least some of the traction ropes 30 at the fixed position of the damper if there is sufficient rope sway. The dampers absorb the vibrational energy in the traction ropes 30 so that energy is not translated into vibrations of the elevator car 22.

Another portion 54 of the traction ropes 30 exists between the counterweight 24 and the sheave 36. The portion 54 has a first end 56 at the counterweight 24 and a second end 58 at the sheave 36. As can be appreciated from the drawing, as the elevator car 22 moves upward and the counterweight 24 moves downward, a length of the portion 54 between the first end 56 and second end 58 increases. Conversely, as the counterweight 24 moves upward (according to the drawing), the length of the portion 54 decreases. It is possible for there to be sway or lateral movement in the portion 54 of the traction ropes 30. The example of FIG. 1 includes dampers 60 and 62 in fixed positions relative to the ends 58 and 56 to reduce the amount of sway in at least the portion 54.

Some example implementations will only include the damper 50. Others will include only the damper 52. Still other examples will include a combination of the dampers 50 and 52. Still other examples will include a combination of two or more of the dampers 50, 52, 60 and 62. Given this description, those skilled in the art will be able to determine which damper location or which combination of dampers will provide the desired amount of sway mitigation for vibration reduction.

The illustrated elevator system 20 includes a plurality of compensation ropes 70 (e.g., elongated members such as round ropes). An express run from the top of a high rise building to its entrance level or lobby will tend to have the largest amount of undesired lateral movement of the compensation ropes 70.

A portion 72 of the compensation ropes 70 exists between the counterweight 24 and a sheave 78 near an opposite end of the hoistway compared to the end of the hoistway where the machine 32 is located. The portion 72 includes a first end 74 near the counterweight 24 and a second end 76 at the interface between the compensation ropes 70 and sheave 78. As can be appreciated from the drawing, as the counterweight 24 approaches the sheave 78, the length of the portion 72 decreases. Because the portion 72 of the compensation ropes 70 may move laterally or sway under certain elevator operating conditions, a damper 80 is provided in a fixed position relative to the end 76 of the portion 72. The damper 80 in this example is supported on a hoistway structural member 84 such as a portion of the building near a pit in which the sheave 78 is located, for example. Another damper 82 is provided in this example in a fixed position relative to the first end 74 of the portion 72. The damper 82 is secured to at least one of the compensation ropes 70 in a fixed longitudinal position in one example.

Another portion 86 of the compensation ropes 70 has a first end 88 near the elevator car 22 and second end 90 at an interface between the compensation ropes 70 and a sheave 92. In this example, a damper 94 is provided near the second end 90 and a damper 96 is provided near the first end 88.

The damper 94 is supported on the structural member 84 of the hoistway 26. The damper 96 is secured to at least one of the compensation ropes 70 to remain in a fixed longitudinal position relative to at least the one compensation rope 70.

Some example elevator systems will include all of the dampers 50, 52, 60, 62, 80, 82, 94 and 96. Other example elevator systems will include only a selected one of the dampers. Still others will include different combinations of a selected plurality of the example dampers.

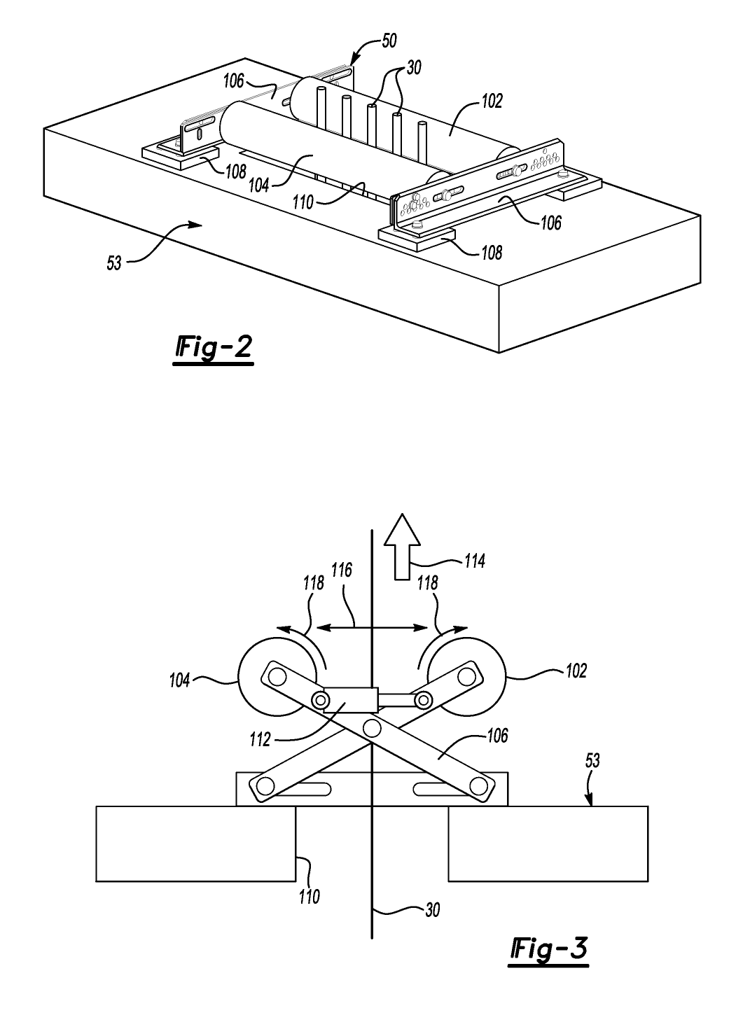

FIG. 2 illustrates one example damper 50. The configuration of the dampers 60, 80 and 94 in FIG. 1 can be the same as that shown in FIG. 2, for example. The damper 50 includes impact members 102 and 104 that are positioned to remain clear of the traction ropes 30 during acceptable elevator operating conditions (e.g., desired longitudinal movement of the ropes without lateral movement). The fixed position of the damper 50 outside of the travel path of the elevator car 22 and the clearance between the ropes and the impact members allow for the damper 50 to remain in a fixed position where the impact members 102 and 104 are ready to mitigate undesired sway of the traction rope 30 at all times. Previously proposed sway mitigation devices that are deployed in the hoistway itself have the disadvantage of having to be moved into an inactive position (where they cannot mitigate sway) to remain clear of the moving elevator car. In other words, the damper 50 is passive in nature in that it does not have to be actively deployed or moved into a position where it will perform a sway mitigating function. This is an advantageous feature of the damper 50 compared to previous sway mitigation members in elevator systems that had to be actively deployed or moved into a sway mitigating position under selected conditions. There is no requirement, for example, to move the damper 50 out of a sway mitigating position to accommodate movement of the elevator car 22. The damper 50 is situated for damping rope sway levels any time that rope sway occurs. The damper 50 is particularly and, in at least some respects, most importantly effective for damping rope sway during long elevator runs which result in significant shortening of the ropes (e.g., shortening of the portion 38).

The impact members 104 and 102 in this example comprise bumpers having rounded surfaces configured to minimize any wear on the traction ropes 30 as a result of impact between the traction ropes 30 and the impact members 102 and 104 resulting from lateral movement of the traction ropes 30. The spacing between the impact members 102 and 104 and the traction ropes 30 minimizes any contact between them except for under conditions where an undesired amount of lateral movement of the ropes 30 is occurring.

In one example, the impact members 102 and 104 comprise rollers that roll about axes responsive to contact with the moving traction ropes 30 under sway conditions.

In the illustrated example, a damper frame 106 supports the impact members 102 and 104 in a desired position to maintain the spacing from the traction ropes 30 under many elevator system conditions. The illustrated example includes mounting pads 108 between the frame 106 and the hoistway structural member 53. The mounting pads 108 reduce any transmission of vibration into the structure 53 as a result of impact between the traction ropes 30 and the impact members 102 and 104, which minimizes the possibility of transmitted noise into the hoistway. In the illustrated example, a spacing between the impact members 102 and 104 is less than a spacing provided in a gap 110 within the floor or structural member 53 through which the traction ropes 30 pass. This closer spacing between the impact members 102 and 104 compared to the size of the gap 110 ensures that the traction ropes 30 will contact the impact members 102 and 104 before having any contact with the structural member 53.

Contacting the traction ropes 30 at the fixed location of the damper 50 disrupts the natural resonance of the traction ropes 30 that is associated with the lateral movement or sway of those ropes. The impact between the traction ropes 30 and the impact members 102 and 104 creates a new nodal point along the length of the portion 38, which disrupts the natural resonance of the rope. Introducing a nodal point in this manner may serve to move energy in the ropes to higher harmonics, which may have more damping effect and consequently further reduce the potential for vibration of the elevator car 22. Any impact between the traction rope 30 and the impact members 102 or 104 reduces the amount of energy associated with lateral movement of the ropes and reduces the amount of vibration occurring at the elevator car 22.

In one example, the impact members 102 and 104 include a resilient material that absorbs some of the energy associated with the lateral movement of the traction ropes 30. Absorbing such energy reduces the amount of sway and elevator car vibration.

FIG. 3 illustrates another example damper configuration in which the impact members 102 and 104 are rollers that rotate responsive to contact with the traction ropes 30 as the ropes are moving longitudinally. In this example, the frame 106 is configured to allow lateral movement of the impact members 102 and 104 responsive to contact with the traction ropes 30. A biasing member 112 urges the impact members 102 and 104 into a rest position where they maintain a spacing from the traction ropes 30 under most conditions. In one example, the biasing member 112 comprises a mechanical spring, a gas spring or a hydraulic shock absorbing device. Impact between the traction ropes 30 and one of the impact members tends to urge that impact member away from the other against the bias of the biasing member 112. This arrangement provides additional energy absorbing characteristics for further reducing the amount of vibrational energy within the rope 30 because energy is expended to overcome the bias of the biasing member 112.

As can be appreciated from the drawing, as the traction rope 30 moves longitudinally as shown by the arrow 114 and laterally as shown by the arrow 116, any impact between the traction ropes 30 and one of the impact members 102 or 104 will cause rotation as schematically shown by the arrows 118 and will tend to urge the impact members away from each other against the bias of the biasing member 112.

Any one of the dampers 50, 60, 80 or 94 may have a configuration as shown in FIG. 2 or 3. Of course, other configurations of those dampers are possible and this invention is not necessarily limited to a particular construction of the damper, itself.

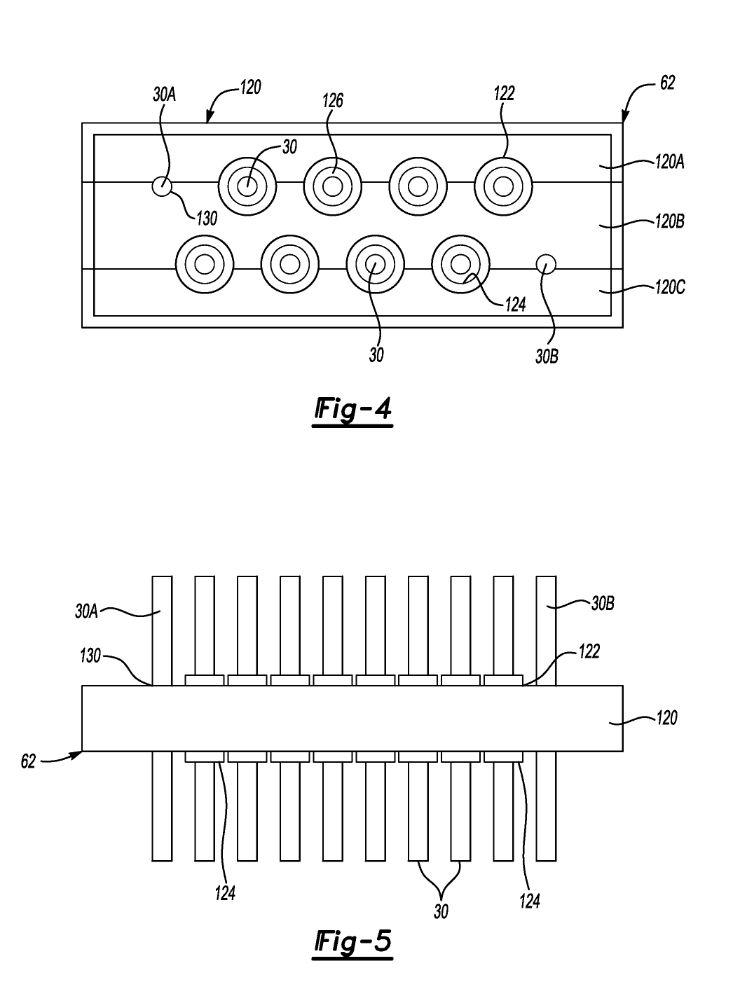

FIGS. 4 and 5 schematically illustrate an example type of damper that may be used as the damper 52, 62, 82 or 96. The damper 62 is shown for discussion purposes. In this example, the damper 62 comprises a base 120 that is rigid. In one example, the base 120 comprises a block that is assembled from several pieces 120a, 120b and 120c that are secured together in a desired position relative to the nearby end of the portion of the ropes of interest.

The base 120 includes a plurality of holes 122 through which the traction ropes 30 are received. Each of the holes 122 has an associated impact member 124 positioned at least partially within the hole 122 such that a clearance or spacing 126 exists between an outer surface of each traction rope 30 and a corresponding one of the impact members 124. As the traction ropes 30 move laterally, they will contact the impact members 124. Such contact has a vibration-reducing effect.

In one example, the impact members 124 comprise an at least partially resilient material for absorbing more of the energy from the traction ropes 30 as a result of impact between the traction ropes 30 and the impact members 124.

In the illustrated example, there are ten traction ropes 30. A first one of the traction ropes 30A and a second one of the traction ropes 30B are selected for securing the base 120 in a fixed longitudinal position relative to the first end 56 (FIG. 1). In this example, the base 120 is rigidly secured against the traction ropes 30A and 30B as they are received in holes 130 within the base 120. The holes 130 in this example have an inside dimension that corresponds to or is slightly less than the outside dimension of the ropes 30A and 30B. By securing the base portions 120A, 120B and 120C together, the base 120 is secured in a fixed longitudinal position relative to the traction ropes 30.

By having essentially no contact with most of the traction ropes 30 except under lateral rope movement or sway conditions, the example damper 62 facilitates reducing the amount of energy in the ropes associated with sway or lateral movement because of contact between at least some of the ropes 30 and the corresponding impact members 124.

The dampers 52, 96, 62 and 82 may each have a configuration like that schematically shown in FIGS. 4 and 5. Alternative configurations are possible and this invention is not necessarily limited to a particular configuration of such a damper.

Providing a damper such as the damper 62 near one end of a portion of the ropes that is of concern for vibration control can be used in combination with a damper that remains in a fixed position relative to an opposite end of that portion of the ropes of concern (e.g., a damper as shown in FIG. 2 or 3). Providing a damper near both ends of the portion of the ropes that is of concern can provide further vibration reduction, for example.

One feature of the example dampers is that they are useful for sway mitigation during elevator operating conditions in which the elevator car 22 is moving. Deployable sway mitigation members that have to be moved into and out of the path of elevator car travel are disfavored for situations in which an elevator car is moving because it is important to keep objects out of the elevator car travel path. In addition, deployable sway mitigation members must be safely retracted during car motions at which time significant lateral sway can build up in the ropes, which will produce car vibrations at the end of long elevator runs. The example dampers are useful for situations involving express elevator runs during which a significant amount of rope sway or lateral movement may occur that could introduce vibrations into an elevator car. Previously suggested damper arrangements do not address that situation. Therefore, the disclosed example damper configurations and placement are superior compared to sway mitigation members that have to be deployed into an active or mitigating position under selected conditions. Additionally, damper configuration is simplified and maintenance is reduced with the disclosed examples.

Another feature of the disclosed examples is that there normally is spacing between the impact members and the ropes. This reduces any concern with wear on the ropes as a result of contact with the impact members over a prolonged period of time. This feature increases the service life of the dampers and avoids shortening the service life of the ropes

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. An elevator system, comprising:
a first mass that is moveable within a hoistway;
a second mass that is moveable within the hoistway;
at least one sheave near one end of the hoistway;
a plurality of elongated members coupling the first mass to the second mass, the elongated members moving over the at least one sheave as the first and second masses move within the hoistway, a portion of the elongated members having a first end at the first mass and a second end at the at least one sheave, the portion of the elongated members having a length between the first and second ends that decreases as the first mass moves toward the one end of the hoistway;
a damper that remains in a fixed position relative to one of the first end or the second end of the portion of the elongated members, the damper including an impact member that is spaced from the portion of the elongated members during acceptable operating conditions, the impact member comprising a bumper on each of at least two opposite sides of the elongated members, the bumpers contacting at least some of the elongated members responsive to lateral movement of the some of the elongated members as the first mass approaches the one end of the hoistway, the damper comprising a biasing member that biases the bumpers into a first position with a first spacing between the bumpers, the bumpers being moveable against the bias of the biasing member responsive to contact with at least one elongated member into a second position with a second, larger spacing between the bumpers.

2. The elevator system of claim 1, wherein
the damper is supported in a fixed position relative to a structure of the hoistway near the at least one sheave.

3. (canceled)

4. The elevator system of claim 1, wherein
the bumpers comprise rollers that are each rotatable about an axis responsive to contact with the at least some of the elongated members.

5. The elevator system of claim 1, wherein
the impact member comprises a resilient material.

6. The elevator system of claim 1, wherein
the bumpers are supported on a frame and a portion of the frame is moveable relative to the structure of the hoistway responsive to contact between the at least some elongated members and the bumpers.

7. The elevator system of claim 1, comprising
a second damper supported on at least one of the elongated members near the first mass such that the damper remains in a selected longitudinal position near the first end of the portion of the elongated members.

8. The elevator system of claim 7, wherein
the second damper comprises a solid base and the impact member comprises a plurality of bumpers supported on the base.

9. The elevator system of claim 8, wherein the second damper bumpers comprise a resilient material.

10. The elevator system of claim 8, wherein
the base comprises a block having a plurality of holes through the block,
each of the at least some of the elongated members is received through one of the holes, and
each second damper bumper comprises a sleeve within a corresponding one of the holes.

11. The elevator system of claim 1, wherein
the first mass comprises an elevator car and the second mass comprises a counterweight.

12. The elevator system of claim 1, wherein
the first mass comprises a counterweight and the second mass comprises an elevator car.

13. The elevator system of claim 1, wherein
the elongated members comprise traction ropes that support the first and second masses.

14. The elevator system of claim 1, wherein
the elongated members comprise compensation ropes coupled to an underside of the first and second masses.

15. The elevator system of claim 1, comprising
a second damper that remains in a fixed position relative to the other one of the first end or the second end of the portion of the elongated members, the second damper including an impact member that is spaced from the portion of the elongated members during acceptable operating conditions, the second damper impact member contacting at least some of the elongated members responsive to lateral movement of the some of the elongated members as the first mass approaches the one end of the hoistway.

16. The elevator system of claim 15, wherein
the damper is supported in a fixed position relative to a structure of the hoistway near the at least one sheave; and
the second damper is supported on at least one of the elongated members near the first mass such that the damper remains in a fixed longitudinal position near the first end of the portion of the elongated members.

17. The elevator system of claim 1, wherein
the elongated members include a second portion having a first end at the second mass and a second end at the at least one sheave, the second portion of the elongated members having a length between the first and second ends that decreases as the second mass moves toward the one end of the hoistway; and comprising
a second damper that remains in a fixed position relative to one of the first end or the second end of the second portion of the elongated members, the second damper including an impact member that is spaced from the second portion of the elongated members during acceptable operating conditions, the impact member contacting at least some of the elongated members responsive to lateral movement of the some of the elongated members as the second mass approaches the one end of the hoistway.

18. The elevator system of claim 17, comprising
a third damper that remains in a fixed position relative to the other one of the first end or the second end of the portion of the elongated members, the third damper including an impact member that is spaced from the portion of the elongated members during acceptable operating conditions, the third damper impact member contacting at least some of the elongated members responsive to lateral movement of the some of the elongated members as the first mass approaches the one end of the hoistway; and
a fourth damper that remains in a fixed position relative to the other one of the first end or the second end of the second portion of the elongated members, the fourth damper including an impact member that is spaced from the second portion of the elongated members during acceptable operating conditions, the fourth damper impact member contacting at least some of the elongated members responsive to lateral movement of the some of the elongated members as the second mass approaches the one end of the hoistway.

19-20. (canceled)
